(19) United States
(12) Patent Application Publication
(10) Pub. No.: US 2015/0294632 A1
(43) Pub. Date: Oct. 15, 2015

(54) LIQUID CRYSTAL PANEL, DRIVING METHOD AND LIQUID CRYSTAL DEVICE

(71) Applicant: Shenzhen China Star Optoelectronics Technology Co., Ltd., Shenzhen (CN)

(72) Inventors: Cheng-hung Chen, Shenzhen City (CN); Tien-hao Chang, Shenzhen City (CN); Shishuai Huang, Shenzhen City (CN)

(21) Appl. No.: 14/346,963

(22) PCT Filed: Jan. 21, 2014
(86) PCT No.: PCT/CN2014/071031

§ 371 Date: Mar. 24, 2014

(30) Foreign Application Priority Data
Dec. 27, 2013 (CN) 201310739015.5

(51) Int. Cl. G09G 3/36; G02F 1/1343

(52) U.S. Cl. CPC G09G 3/3648; G02F 1/134336; G09G 3/3685; G09G 3/3674; G09G 2310/0227; G09G 2310/0237; G09G 2310/0248; G09G 2310/08; G09G 2310/0289; G09G 2320/0233; G09G 2320/046; G09G 2320/0613

(57) ABSTRACT

A liquid crystal panel includes a plurality of pixels arranged in a matrix form, a plurality of charge-filling gate lines, and a plurality of charge-sharing gate lines. Each pixel column electrically couples to one charge-filling gate line and one charge-sharing gate line. The charge-sharing gate line electrically coupled with the n-th pixel column is electrically coupled with the charge-filling gate line electrically coupled with the (n+m)-th pixel column The charge-filling gate line electrically coupled with each pixel column is inputted with first driving signal when the liquid crystal panel is driven in a 2D display mode and is inputted with second driving signals when the liquid crystal panel is driven in a 3D display mode. In addition, a driving method of the liquid crystal panel and the liquid crystal device incorporating the liquid crystal panel are disclosed.

### BACKGROUND OF THE INVENTION

1. Field of the Invention

The present disclosure relates to liquid crystal display technology, and more particularly to a liquid crystal panel, a driving method and a liquid crystal display (LCD).

2. Discussion of the Related Art

With the technical development, three dimension (3D) display technology has brought three-dimensional vision for observers. Different images are respectively received by the left eye and the right eye, and are then overlapped by the brain to form images with front-rear, up-down, left-right, far-close three dimensional effects.

Currently, 3D display devices relate to the display devices capable of switching between 2D and 3D. That is, the display device operates in the 2D display mode while the 3D display mode has not been activated. The display device operates in the 3D display mode after the 3D display mode is activated.

For large-scale 3D display device, when operating in the 2D display mode, usually the low color shift design, i.e., increasing the domain of pixels, is adopted in the display panel so as to enlarge the viewing angle and to reduce the color shift. One pixel is divided into four domains. One pixel includes eight domains if the pixel is further divided into a main-area and a sub-area. As such, the viewing angle of the display panel can be enlarged, and the color shift can be enhanced. FIG. 1 is an equivalent circuit diagram of one typical display panel of low color shift. As shown in FIG. 1, the pixel is divided into a main-area 11 and a sub-area 12. When the charge line (CL) is turned on, the charges are transmitted respectively to the main-area and the sub-area of the pixel via the thin film transistor (TFT) (MT) in the main-area 11 and the TFT ST in the sub-area 12. When the charge line (CL) is turned off and the share line (SL) is turned on, ST electrically coupling to the charge-sharing gate line (SL) releases a portion of the charges within the sub-area 12 to the capacitor (Cb). In this way, potential difference occurs between the main-area 11 and the sub-area 12 of the pixel so as to achieve the low color shift.

FIG. 2a is a schematic view of the 3D display mode when adopting the one-frame-inversed driving method. As the average values of the positive/negative polarity of the voltage stored in the pixel cannot be offset, the images may remain on the display panel, i.e., IS burn-in effect. As shown in FIG. 2b, one solution to solve the IS burn-in effect is to adopt the two-frame-inversed driving method, instead of one-frame-inversed driving method, such that the average values of the positive/negative polarity of the voltage stored in the pixel is consistent. However, after changing the driving method, the pixel may not be consistently charged when the positive/negative polarity of the voltage stored in the pixel is changed due to the capacitor (Cb) in FIG. 1. As such, the brightness of the images may differ for the left eye and the right eye.

In addition, regarding the driving method for the pixels of the display panel, each pixel column is driven by the charge line (CL) and the gate line (SL) charged by independent charges. Thus, the low color shift is achieved by respectively turning on or off the charge line (CL) and the gate line (SL). The low color shift can be turned off by turning off the gate line (SL). However, while the charge line (CL) and the charge line (CL) are independently designed, two times of the number of the chip on film (COF) is needed to provide signals for the charge line (CL) and the gate line (SL).

In order to reduce the number of the COF and the cost, another solution regarding the low color shift is to turn on the gate line (SL) by the charge line (CL), which is turned on after the gate line (SL) is turned on. As shown in FIG. 3, for example, the N-th gate line (SL) may be turned on by turning on the (N+2)-th charge line (CL). However, the gate line (SL) cannot be independently turned on or off under such design. Thus, the low color shift cannot be disabled by turning off the gate line (SL). As such, IS burn-in effect and brightness difference for the left and right eye may occur in the 3D display mode.

### SUMMARY

In one aspect, a liquid crystal panel includes: a plurality of pixels, a plurality of charge-filling gate lines, and a plurality of charge-sharing gate lines, wherein the plurality of pixels are arranged in a matrix form, each pixel column electrically couples to one charge-filling gate line and one charge-sharing gate line, and the charge-sharing gate line electrically coupled with the n-th pixel column is electrically coupled with the charge-filling gate line electrically coupled with the (n+m)-th pixel column; and the charge-filling gate line electrically coupled with each pixel column is inputted with a first driving signal when the liquid crystal panel is driven in a 2D display mode, and the charge-filling gate line electrically coupled with each pixel column is inputted with a second driving signal when the liquid crystal panel is driven in a 3D display mode.

Wherein the duration of a turn-on signal of the second driving signal is at least m times the duration of the turn-on signal of the first driving signal.

Wherein the second driving signal is an interleaved driving signal having interleaved turn-on signal and turn-off signal.

Wherein the duration of the turn-on signal and the duration of the turn-off signal are the same with the duration of the turn-on signal of the first driving signal.

In another aspect, a driving method of a liquid crystal panel is disclosed. The liquid crystal panel includes a plurality of pixels, a plurality of charge-filling gate lines, and a plurality of charge-sharing gate lines, wherein the plurality of pixels are arranged in a matrix form, each pixel column electrically couples to one charge-filling gate line and one charge-sharing gate line, and the charge-sharing gate line electrically coupled with the n-th pixel column is electrically coupled with the charge-filling gate line electrically coupled with the (n+m)-th pixel column, the method includes: inputting a first driving signal to the charge-filling gate lines electrically coupled with each pixel column when the liquid crystal panel is driven in a 2D display mode; and inputting a second driving signal to the charge-filling gate lines electrically coupled with each pixel column when the liquid crystal panel is driven in a 3D display mode.

Wherein the duration of a turn-on signal of the second driving signal is at least m times the duration of the turn-on signal of the first driving signal.

Wherein the second driving signal is an interleaved driving signal having interleaved turn-on signal and turn-off signal.

Wherein the duration of the turn-on signal and the duration of the turn-off signal are the same with the duration of the turn-on signal of the first driving signal.

In another aspect, a liquid crystal device includes: a liquid crystal panel and a backlight light module arranged opposite to the liquid crystal panel, the backlight module provides a display light source to the liquid crystal panel such that the liquid crystal panel is capable of displaying images, wherein the liquid crystal panel includes a plurality of pixels, a plurality of charge-filling gate lines, and a plurality of charge-sharing gate lines, wherein the plurality of pixels are arranged in a matrix form, each pixel column electrically couples to one charge-filling gate line and one charge-sharing gate line, and the charge-sharing gate line electrically coupled with the n-th pixel column is electrically coupled with the charge-filling gate line electrically coupled with the (n+m)-th pixel column, and the charge-filling gate line electrically coupled with each pixel column is inputted with a first driving signal when the liquid crystal panel is driven in a 2D display mode, and the charge-filling gate line electrically coupled with each pixel column is inputted with a second driving signal when the liquid crystal panel is driven in a 3D display mode.

Wherein the duration of a turn-on signal of the second driving signal is at least m times the duration of the turn-on signal of the first driving signal.

Wherein the second driving signal is an interleaved driving signal having interleaved turn-on signal and turn-off signal.

Wherein the duration of the turn-on signal and the duration of the turn-off signal are the same with the duration of the turn-on signal of the first driving signal.

In view of the above, the IS burn-in effect and brightness difference for the left and right eye are avoided for the liquid crystal panel and the driving method thereof and the liquid crystal device

### BRIEF DESCRIPTION OF THE DRAWINGS

FIG. 1 is an equivalent circuit diagram of one typical display panel of low color shift.

FIGS. 2a and 2b are schematic views showing the 3D display mode of the typical display panel of low color shift.

FIG. 3 is a schematic view of one typical display panel of low color shift when being driven.

FIG. 4 is a schematic view of the liquid crystal panel in accordance with one embodiment.

FIG. 5 is a schematic view of the liquid crystal panel of FIG. 4 when it is driven to operate in the 2D display mode.

FIG. 6 is a schematic view of the liquid crystal panel of FIG. 4 when it is driven to operate in the 3D display mode.

FIG. 7 is a schematic view of the liquid crystal panel of FIG. 4 when it is driven to operate in the 3D display mode in accordance with another embodiment.

FIG. 8 is a schematic view of the liquid crystal device including the liquid crystal panel of FIG. 4.

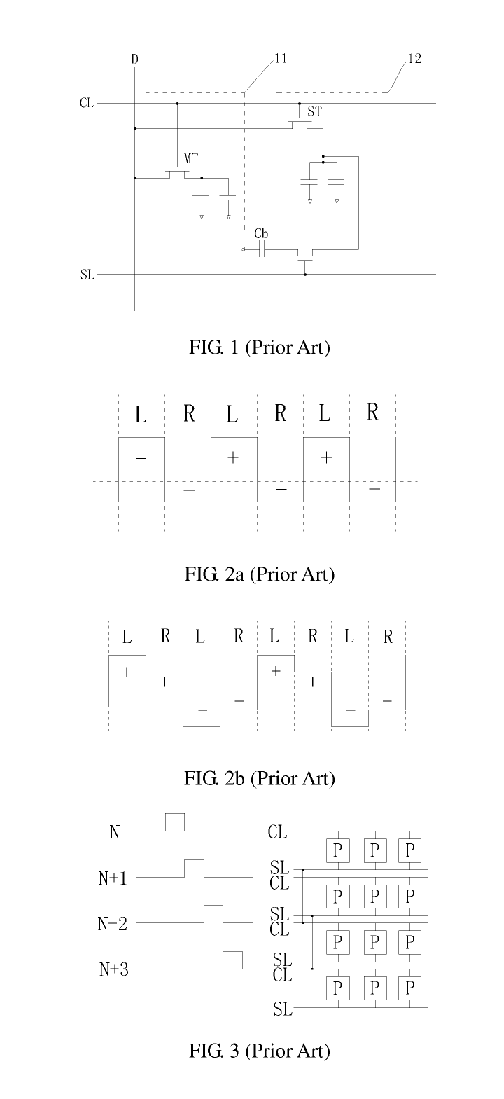

### DETAILED DESCRIPTION OF THE EMBODIMENTS

Various example embodiments will now be described more fully with reference to the accompanying drawings in which some example embodiments are shown. In the drawings, the thicknesses of layers and regions may be exaggerated for clarity. In the following description, in order to avoid the known structure and/or function unnecessary detailed description of the concept of the invention result in confusion, well-known structures may be omitted and/or functions described in unnecessary detail.

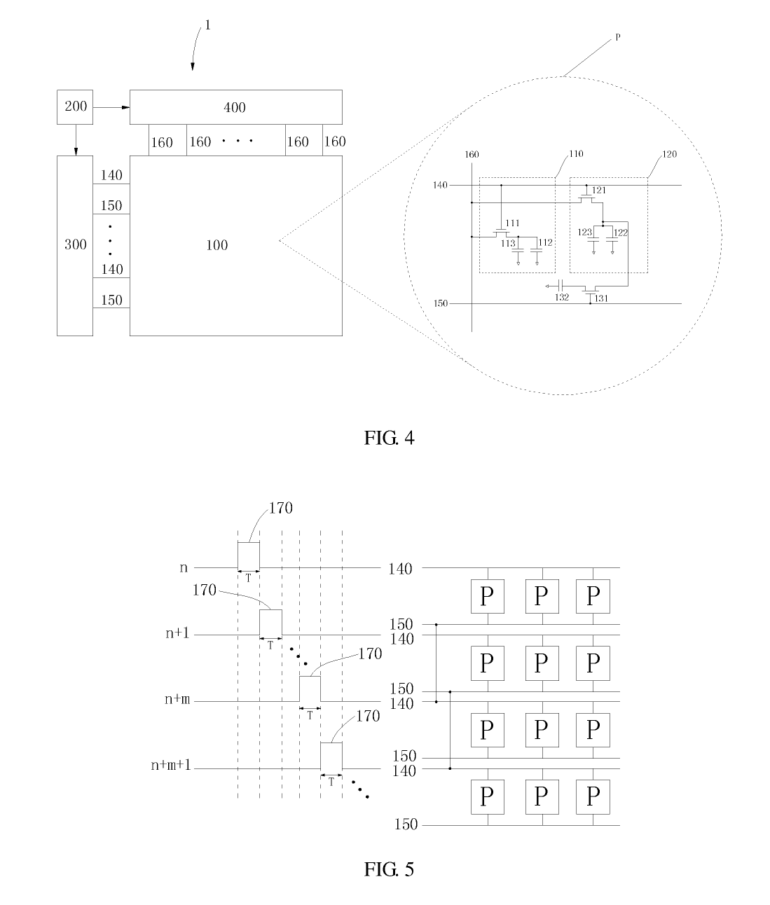

FIG. 4 is a schematic view of the liquid crystal panel in accordance with one embodiment.

Referring to FIG. 4, the liquid crystal panel 1 is for installing in the liquid crystal device. The liquid crystal panel 1 is arranged opposite to the backlight module of the liquid crystal device. The backlight module provides a display light source to the liquid crystal panel 1 such that the liquid crystal panel 1 can display the images. The liquid crystal panel 1 includes a display area 100, a timing controller 200, a gate driver 300, and a data driver 400.

The display area 100 includes a plurality of pixels (P) arranged in a matrix-form. In order to reduce the color shift of the liquid crystal panel 1, each of the pixels (P) is divided into a main-area 110 and a sub-area 120. Each of the pixels (P) includes three thin film transistors (TFTs), a common capacitor 132, a liquid crystal capacitor 112 and a storage capacitor 113 for the main-area 110, and the liquid crystal capacitor 122 and the storage capacitor 123 for the sub-area 120. The three TFTs are respectively a common TFT 131, a TFT 111 for the main-area 110, and a TFT 121 for the sub-area 120. The gates of the TFT 111 and the TFT 121 electrically couple with a gate line 140, and the drains of the TFT 111 and the TFT 121 electrically couple with a data line 160. The sources of the TFT 111 electrically couples with the liquid crystal capacitor 112 and the storage capacitor 113. The source of the TFT 121 electrically couples with the liquid crystal capacitor 122 and the storage capacitor 123. The gate of the common TFT 131 electrically couples with a charge-sharing gate line 150. The drain of the common TFT 131 electrically couples with the source of the TFT 121. The source of the common TFT 131 electrically couples with the common capacitor 132.

The timing controller 200 re-configures the digital video data received by a system board (not shown) of the liquid crystal panel 1, and provides the re-configured digital video data to the data driver 400. The timing controller 200 receives, for example, vertical synchronous signals, horizontal synchronous signals, data enable signals, and clocks, from the system board so as to generate timing control signals for controlling the operation clocks of the data driver 400 and the scanning driver 300.

The data driver 400 saves the digital video data (RGB) and converts the stored digital video data (RGB) when being controlled by the timing controller 200. Thus, a positive data voltage and a negative data voltage are generated. Afterward, the data driver 400 provides the positive data voltage and the negative data voltage to each of the data line 160. The scanning driver 300 sequentially provides the turn-on signal having the width equaling to one horizontal period (about the period of one frame) to each of the charge-filling gate line 140 when being controlled by the timing controller 200. For example, when one of the charge-filling gate line 140 is applied with the positive data voltage which is large enough, the TFTs connected to the charge-filling gate line 140 are turned on. At this moment, the drains of the TFT connected to the charge-filling gate line 140 are connected to all of the data lines 160 such that the data voltage, including the positive data voltage or the negative data voltage, from each data lines 160 charges all of the corresponding pixels (P) of the charge-filling gate line 140 until an appropriate voltage is reached. Afterward, a large enough negative voltage is applied to the charge-filling gate line 140 to turn off the gate of the TFTs connected to the charge-filling gate line 140 until the gate of the TFTs are turned on next time. Within the duration, the charges are saved on the liquid crystal capacitor 112 and the liquid crystal capacitor 122. At this moment, the next charge-filling gate line 140 is turned on so as to charge each pixels (P) on the next charge-filling gate line 140. The video data of the whole images is written sequentially and then the process re-start from the first charge-filling gate line 140. The frequency of the re-start process is the reciprocal of the time period of one frame.

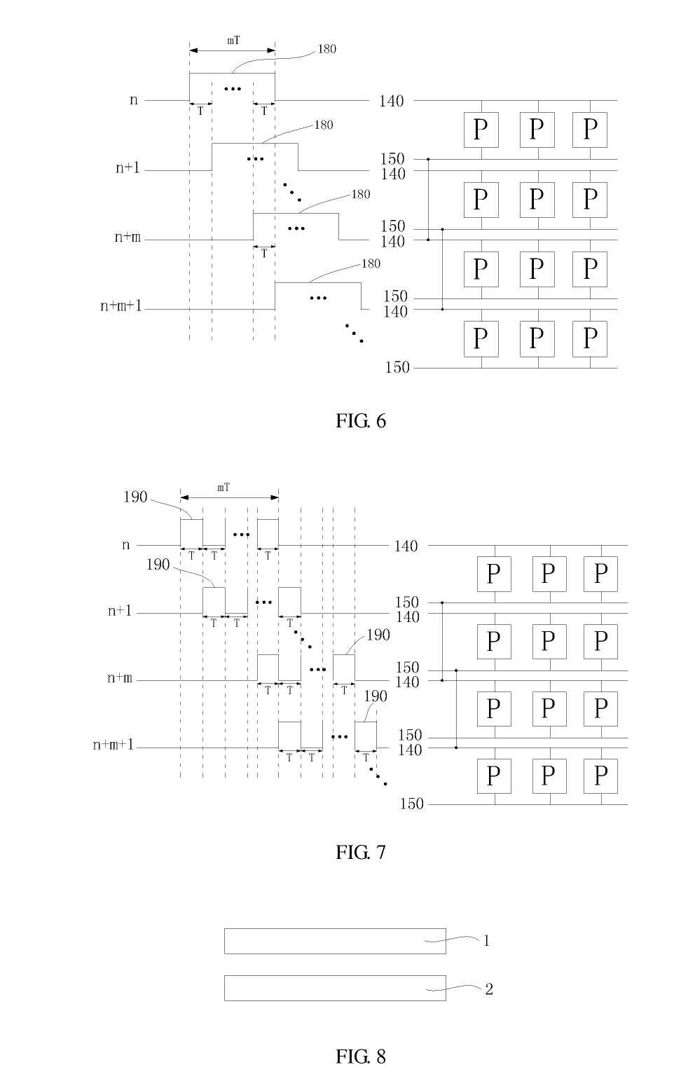

The driving process of the liquid crystal panel in accordance with one embodiment will be described hereinafter. FIG. 5 is a schematic view of the liquid crystal panel of FIG. 4 when it is driven to operate in the 2D display mode. FIG. 6 is a schematic view of the liquid crystal panel of FIG. 4 when it is driven to operate in the 3D display mode. It is to be noted that the driving signals for the 2D display mode and the 3D display mode of the liquid crystal panel 1 are different.

Referring to FIGS. 4, 5 and 6, as stated above, the liquid crystal panel 1 includes a plurality of pixels (P), a plurality of charge-filling gate lines 140, and a plurality of charge-sharing gate line 150. The pixels (P) are configured in the matrix form. Each pixel column electrically couples with one charge-filling gate line 140 and with one charge-sharing gate line 150. The charge-sharing gate line 150 electrically coupled with the n-th pixel column is electrically coupled with the charge-filling gate line 140 electrically coupled with the (n+m)-th pixel column .

As stated above, when the liquid crystal panel 1 is driven in the 2D display mode, the charge-filling gate line 140 electrically coupled with the n-th pixel column is inputted with a first driving signal 170. The main-area 110 and the sub-area 120 are fully charged, and Vm=Vsub, wherein Vm denotes the voltage charged to the main-area 110, and Vsub denotes the voltage charged to the sub-area 120. When the charge-filling gate line 140 electrically coupled with the (n+m)-th pixel column is inputted with the first driving signal 170, as the charge-sharing gate line 150 of the n-th pixels (P) is electrically coupled with the charge-filling gate line 140 electrically coupled with the (n+m)-th pixel column, the charge-sharing gate line 150 electrically coupled with the n-th pixel column is also inputted with the first driving signal 170. In this way, the sub-area 120 discharges toward the common capacitor 132 such that Vm>Vsub. Thus, the liquid crystal panel 1 achieves the low color shift effect in the 2D display mode. The duration of turn-on (ON) signals (or high level) of first driving signal 170 is represented by T.

When the liquid crystal panel 1 operates in the 3D display mode, the charge-filling gate line 140 electrically coupled with the n-th pixel column is inputted with a second driving signal 180. Within the duration of the turn-on (ON) signals (or high level) of the second driving signal 180, the charge-filling gate lines 140 respectively electrically coupled with the (n+1) pixel column and the (n+m)-th pixel column are inputted with the turn on (ON) signals (or high level) of the second driving signal 180. At this moment, as the charge-sharing gate line 150 electrically coupled with the n-th pixel column is electrically coupled with the charge-filling gate line 140 electrically coupled with the (n+m)-th pixel column, the charge-sharing gate line 150 electrically coupled with the n-th pixel column is also inputted with the turn on (ON) signals (or high level) of the second driving signal 180. In this way, the common capacitor 132 of the sub-area 120 is turned on. The common capacitors 132 of the main-area 110 and the sub-area 120 are fully charged. The Vm=Vsub=V₁₃₂, wherein Vm denotes the voltage charged to the main-area 110, Vsub denotes the voltage charged to the sub-area 120, and V₁₃₂ denotes the voltage charged to the common capacitor 132. When the charge-filling gate line 140 electrically coupled with the (n+m)-th pixel column is inputted with the turn on (ON) signals (or high level) of the second driving signal 180, the charge-sharing gate line 150 electrically coupled with the n-th pixel column is also inputted with the turn on (ON) signals (or high level) of the second driving signal 180. As the common capacitor 132 is fully charged, the sub-area 120 is unable to discharge toward the common capacitor 132 such that Vm=Vsub. In this way, the low color shift is inactivated when the liquid crystal panel 1 operates in the 3D display mode. Thus, the IS burn-in effect and bright difference between the left eye and the right eye is avoided.

In order to achieve the above purposes, the duration of the turn on (ON) signals (or high level) of the second driving signal 180 is at least m times the duration of the turn on (ON) signals (or high level) of the first driving signal 170. That is, the duration of the turn on (ON) signals (or high level) of the second driving signal 180 is at least mT.

FIG. 7 is a schematic view of the liquid crystal panel of FIG. 4 when it is driven to operate in the 3D display mode in accordance with another embodiment. The second driving signal 180 may be converted to an interleaved driving signal 190. The interleaved driving signal 190 is a repeated pulse sequence including the turn on (ON) signals or turn off (OFF) signals with the pulse, i.e., duration, equaling to T, which is the duration of the turn on (ON) signals (or high level) of the first driving signal 170. In addition, the duration of the interleaved driving signal 190 is at least m times of the duration of the turn on (ON) signals (or high level) of the first driving signal 170. That is, the duration of the interleaved driving signal 190 is at least mT. Comparing to the second driving signal 180, which remains in the turn-on state, it is easier to control the duration of the interleaved driving signal 190, and the flashing is avoided.

Referring to FIGS. 4, 5, and 7, when the liquid crystal panel 1 is driven to operate in the 2D display mode, the charge-filling gate line 140 electrically coupled with the n-th pixel column is inputted with the first driving signal 170. The main-area 110 and the sub-area 120 are fully charged, and Vm=Vsub, wherein Vm denotes the voltage charged to the main-area 110, and Vsub denotes the voltage charged to the sub-area 120. When the charge-filling gate line 140 electrically coupled with the (n+m)-th pixel column is inputted with the first driving signal 170, as the charge-sharing gate line 150 of the n-th pixels (P) is electrically coupled with the charge-filling gate line 140 electrically coupled with the (n+m)-th pixel column, the charge-sharing gate line 150 electrically coupled with the n-th pixel column is also inputted with the first driving signal 170. In this way, the sub-area 120 discharges toward the common capacitor 132 such that Vm>Vsub. Thus, the liquid crystal panel 1 achieves the low color shift effect in the 2D display mode. The duration of turn-on (ON) signals (or high level) of first driving signal 170 is represented by T.

When the liquid crystal panel 1 operates in the 3D display mode, the charge-filling gate line 140 electrically coupled with the n-th pixel column is inputted with turn on (ON) signals of the interleaved driving signal 190. Within the duration for which the charge-filling gate line 140 electrically coupled with the n-th pixel column is inputted with the interleaved driving signal 190, the charge-filling gate lines 140 respectively coupled with the (n+2)-th pixel column, (n+4)-th pixel column, . . . , and the (n+m)-th pixel column are inputted with the turn on (ON) signals of the interleaved driving signal 190. At this moment, as the charge-sharing gate line 150 electrically coupled with the n-th pixel column is electrically coupled with the charge-filling gate line 140 electrically coupled with the (n+m)-th pixel column, the charge-sharing gate line 150 electrically coupled with the n-th pixel column is also inputted with the turn on (ON) signals of the interleaved driving signal 190. The common capacitor 132 of the sub-area 120 is turned on. The common capacitors 132 of the main-area 110 and the sub-area 120 are fully charged. The Vm=Vsub=V₁₃₂, wherein Vm denotes the voltage charged to the main-area 110, Vsub denotes the voltage charged to the sub-area 120, and V₁₃₂ denotes the voltage charged to the common capacitor 132.

When the charge-filling gate line 140 electrically coupled with the (n+m)-th pixel column is inputted with the turn on (ON) signals of the interleaved driving signal 190, the charge-sharing gate line 150 electrically coupled with the n-th pixel column is also inputted with the turn on (ON) signals of the interleaved driving signal 190. As the common capacitor 132 is fully charged, the sub-area 120 is unable to discharge toward the common capacitor 132 such that Vm=Vsub. In this way, the low color shift is inactivated when the liquid crystal panel 1 operates in the 3D display mode. Thus, the IS burn-in effect and bright difference between the left eye and the right eye is avoided.

FIG. 8 is a schematic view of the liquid crystal device including the liquid crystal panel of FIG. 4. The liquid crystal panel 1 is arranged opposite to the backlight module 2 to form the liquid crystal device. The backlight module provides the display light source to the liquid crystal panel 1 such that the liquid crystal panel 1 can display the images.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A liquid crystal panel, comprising:
a plurality of pixels, a plurality of charge-filling gate lines, and a plurality of charge-sharing gate lines, wherein the plurality of pixels are arranged in a matrix form, each pixel column electrically couples to one charge-filling gate line and one charge-sharing gate line, and the charge-sharing gate line electrically coupled with the n-th pixel column is electrically coupled with the charge-filling gate line electrically coupled with the (n+m)-th pixel column; and
the charge-filling gate line electrically coupled with each pixel column is inputted with a first driving signal when the liquid crystal panel is driven in a 2D display mode, and the charge-filling gate line electrically coupled with each pixel column is inputted with a second driving signal when the liquid crystal panel is driven in a 3D display mode.

2. The liquid crystal panel as claimed in claim 1, wherein the duration of a turn-on signal of the second driving signal is at least m times the duration of the turn-on signal of the first driving signal.

3. The liquid crystal panel as claimed in claim 2, wherein the second driving signal is an interleaved driving signal having interleaved turn-on signal and turn-off signal.

4. The liquid crystal panel as claimed in claim 3, wherein the duration of the turn-on signal and the duration of the turn-off signal are the same with the duration of the turn-on signal of the first driving signal.

5. A driving method of a liquid crystal panel, the liquid crystal panel comprises a plurality of pixels, a plurality of charge-filling gate lines, and a plurality of charge-sharing gate lines, wherein the plurality of pixels are arranged in a matrix form, each pixel column electrically couples to one charge-filling gate line and one charge-sharing gate line, and the charge-sharing gate line electrically coupled with the n-th pixel column is electrically coupled with the charge-filling gate line electrically coupled with the (n+m)-th pixel column, the method comprising:
inputting a first driving signal to the charge-filling gate lines electrically coupled with each pixel column when the liquid crystal panel is driven in a 2D display mode; and
inputting a second driving signal to the charge-filling gate lines electrically coupled with each pixel column when the liquid crystal panel is driven in a 3D display mode.

6. The driving method as claimed in claim 5, wherein the duration of a turn-on signal of the second driving signal is at least m times the duration of the turn-on signal of the first driving signal.

7. The driving method as claimed in claim 6, wherein the second driving signal is an interleaved driving signal having interleaved turn-on signal and turn-off signal.

8. The driving method as claimed in claim 7, wherein the duration of the turn-on signal and the duration of the turn-off signal are the same with the duration of the turn-on signal of the first driving signal.

9. A liquid crystal device, comprising:
a liquid crystal panel and a backlight light module arranged opposite to the liquid crystal panel, the backlight module provides a display light source to the liquid crystal panel such that the liquid crystal panel is capable of displaying images, wherein the liquid crystal panel comprises a plurality of pixels, a plurality of charge-filling gate lines, and a plurality of charge-sharing gate lines, wherein the plurality of pixels are arranged in a matrix form, each pixel column electrically couples to one charge-filling gate line and one charge-sharing gate line, and the charge-sharing gate line electrically coupled with the n-th pixel column is electrically coupled with the charge-filling gate line electrically coupled with the (n+m)-th pixel column; and
the charge-filling gate line electrically coupled with each pixel column is inputted with a first driving signal when the liquid crystal panel is driven in a 2D display mode, and the charge-filling gate line electrically coupled with each pixel column is inputted with a second driving signal when the liquid crystal panel is driven in a 3D display mode.

10. The liquid crystal device as claimed in claim 9, wherein the duration of a turn-on signal of the second driving signal is at least m times the duration of the turn-on signal of the first driving signal.

11. The liquid crystal device as claimed in claim 10, wherein the second driving signal is an interleaved driving signal having interleaved turn-on signal and turn-off signal.

12. The liquid crystal device as claimed in claim 11, wherein the duration of the turn-on signal and the duration of the turn-off signal are the same with the duration of the turn-on signal of the first driving signal.
